(19) United States
(12) Patent Application Publication
(10) Pub. No.: US 2023/0259997 A1
(43) Pub. Date: Aug. 17, 2023

(54) Curated Collections Based On Templates

(71) Applicant: CurioSearch DBA Materiall, Milpitas, CA (US)

(72) Inventors: Bharat Vijay, Fremont, CA (US); Jayanth Vijayaraghavan, Palo Alto, CA (US); Rajiv Ramaratnam, Morgan Hill, CA (US)

(73) Assignee: CurioSearch DBA Materiall, Milpitas, CA (US)

(21) Appl. No.: 17/581,007

(22) Filed: Jan. 21, 2022

(51) Int. Cl. G06Q 30/06

(52) U.S. Cl. CPC G06Q 30/0603; G06Q 30/0643

(57) ABSTRACT

Described herein is a method and system for collection creation. The collection is a curated selection of product and/services presented to an online consumer. The products or services are derived from an electronic catalogue of an online store. The collection creation system comprises a processor, a collection creation application module installed on the online store, a database repository of templates, and a memory containing instructions, when executed by the processor, configure the system to apply the templates to the electronic catalog to automatically create curated collections of product items; and to activate the create collections and display the collections to the online consumer. A curated collection consists of a set of defined parameters for a particular theme. Curated collections enable the retailer’s consumers to browse the inventory of the retailer in an intelligent and thematic manner.

### BACKGROUND

This invention in general relates to ecommerce, and specifically relates to a method and system of engaging with an online consumer in an ecommerce site.

Existing electronic/online catalogues of products and services presented to consumers in an ecommerce site do not satisfactorily reflect the consumer’s interest.

Currently, online stores have a low conversion rate compared to brick and mortar stores. In order to increase purchase conversion rates in ecommerce sites, much of the desirable offline store experience needs to be brought into online stores. The offline stores have the ability to sort and present items in creative ways, for example through organized and attractive presentations of apparel on mannequins and display sets. Currently, in the online world, the information relating to products and services is ineffectively presented to the consumer, as the information is either highly scattered, or jumbled up, or each product overshadows the other, or the product selection is too vast and diluted. The online shopping experience now resembles visiting a seemingly disorganized large warehouse of items in which the customer gets lost in a disorganized and ineffective presentation of items.

Therefore, there is an unmet need for effective product and service presentations in online stores that meets consumer expectations and increases online purchase conversion rates.

### SUMMARY OF THE INVENTION

Described herein is a system and method of creating collections from templates. The templates are applied onto the catalogue (s) of the ecommerce store to create curated collection (s) that best meets the needs of the consumer’s product or service interests.

A collection creation system creates a curated selection of items presented to an online consumer. The curated selection of items are derived from an electronic catalog of items in an online store. The collection creation system comprises a collection creation application module installed on the online store; and a database repository of templates, wherein each template is a blueprint for a set of collections that have the same attributes and similar themes. The templates are defined by one or more of: verticals, categories, attributes, metrics, and text filters. The method includes the following processes. Determine the attributes of the items of catalog by an attribute classification model. Select templates that match a minimum number of the template’s attributes with the item’s attributes. Apply the selected templates to the items of electronic catalog to automatically create curated collections. Activate curated collections and display the curated collections to the online consumer on a user interface.

A curated collection consists of a set of defined parameters for a particular theme. The themes are then applied to a retailer’s catalogue for selecting products from that catalogue, thereafter creating a curated collection of those products. Curated collections allow the retailer’s consumers to browse the inventory of the retailer in an intelligent and thematic manner.

The templates encapsulate various attributes of the product. For example, in the case of apparel, themes could encapsulate color, fit, length, type, patterns, styles; and, could also map these attributes to concepts like Zodiac signs. It is well known that consumers with particular Zodiac signs have propensities for specific colors, styles and patterns. These templates can either be captured as images or as a set of attributes. These templates are mapped to a retailers catalogue using a combination of image, text processing, retailers own cataloguing and data tagging. Themes can be picked up either by human intelligence, or by a designer, or a domain expert. The above mentioned template based approach covers all types of merchandising that requires visual and non visual attribute matching.

A collection presented to a consumer on an ecommerce website is a grouping of products than can be automatically created based on worldwide trends in clothing and apparel, seasonal trends, attribute and price sensitivity. In addition, collections can be configured to filter out low performing and poorly reviewed products.

Products can be showcased to consumers that are fine tuned to the persona of the shopper. For example, for each Zodiac sign, particular styles are chosen and applied to the inventory of apparel. During festivals, thematic collections are created and presented to the customer.

The templates encapsulate various attributes of the product. For example, in the case of apparel, themes could encapsulate color, fit, length, type, patterns, styles; and, could also map these attributes to concepts like Zodiac signs. It is well known that consumers with particular Zodiac signs have propensities for specific colors, styles and patterns. These templates can either be captured as images or as a set of attributes. These templates are mapped to a retailers catalogue using a combination of image, text processing, retailers own cataloguing and data tagging. Themes can be picked up either by human intelligence, or by a designer, or a domain expert. The above mentioned template based approach covers all types of merchandising that requires visual and non visual attribute matching.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a collection creation system to create a curated selection of items presented to an online consumer. The collection creation system also includes a collection creation application module installed on said online store; a repository of templates, where each template is a blueprint for a set of collections that have the same attributes and similar themes, and where said templates are defined by one or more of: verticals, categories, attributes, metrics, and text filters; a processor; and a memory containing instructions, when executed by the processor, configure the system to: determine the attributes of the items of catalog by an attribute classification model; select templates that match a minimum number of the template’s attributes with the item’s attributes; apply said selected templates to said items of electronic catalog to automatically create curated collections. The system also includes activate said curated collections; and display said curated collections to the online consumer on a user interface. Other embodiments of this aspect include corresponding computer systems, apparatus, and computer programs recorded on one or more computer storage devices, each configured to perform the actions of the methods.

One general aspect includes a computer implemented method of creating a collection. The computer implemented method of creating also includes providing a collection creation application module installed on said online store; providing a repository of global templates, determining the attributes of the items included in the electronic of catalog by an attribute classification model, selecting templates that match a minimum number of the template’s attributes with the item’s attributes, applying said selected templates to said items included in the of electronic catalog to automatically create curated collections. The creating also includes activating said curated collections; and displaying said curated collections to the online consumer on a user interface. Other embodiments of this aspect include corresponding computer systems, apparatus, and computer programs recorded on one or more computer storage devices, each configured to perform the actions of the methods.

Implementations may include one or more of the following features. The method where attributes, metrics, filters, and categories of said global templates are applied to the electronic catalog to automatically create curated collections. As a prerequisite to belong to a collection, a product must match a minimum subset of attributes, metrics, filters, and categories of said global template. If there is no exact match of a color attribute, identify and include product items whose color is in close proximity to the color(s) specified in the template. The method may include presenting said automatically curated collection on a website to a subject matter expert for inputs of addition or removal of product items within said automatically curated collections, and thereafter providing a refined set of curated collections. Said template is a blueprint for a set of collections that have the same attributes and similar themes. The method may include defining said template by verticals, categories, attributes, metrics, and text filters. Said template is a system template that is created by developers based on store metrics. Said template is a trending template that creates collections of products that are top sellers. Said template is a brand name look alike template that is applied to said electronic catalog to create collections of products from a store that resemble high end branded products. Said template is a celebrity template that is applied to said electronic catalog to create collections of products from a store’s catalogue that resemble outfits worn by celebrities. Said templates are created by developers based on system metrics in combination with attributes, filters, metrics, and categories. A collection is marked activated either automatically by the platform or by an administrator. When a store owner adds a collection after a notification, the collection is in usable state and the store owner can now place the collection on pages of his or her store. The collection can be updated with new products added to it or with some products removed from it, and where after said updation, an electronic notification is transmitted sent either by an administrator or by the platform to the device associated with a store owner. A collection is marked updated and activated when a store owner approves the update. A collection may be marked deactivated by a subject matter expert. Implementations of the described techniques may include hardware, a method or process, or computer software on a computer-accessible medium.

### BRIEF DESCRIPTION OF FIGURES

FIG. 1 illustrates the method of creating collections.

FIG. 2 illustrates the online ecommerce ecosystem comprising templates and collections.

FIG. 3 illustrates a method of creating a template and a curated collection.

FIG. 4 illustrates a system for generating templates.

FIG. 5A exemplarily illustrates a user interface for the provision of a name and description of a collection.

FIG. 5B exemplarily illustrates a user interface for selecting a tag to select a vertical, e.g., clothing.

FIG. 6A exemplarily illustrates the step of clicking and selecting products for a collection.

FIG. 6B exemplarily illustrates the step of selecting a template, example “cancer men”.

FIG. 7A exemplarily illustrates the addition of add new filters, metrics and colors as necessary.

FIG. 7B exemplarily illustrates the view of the collection.

FIG. 8 illustrates the training for attributes using an attribute classification model.

FIG. 9 illustrates the probabilities based on the attributes.

### DETAILED DESCRIPTION

In the following description, for purposes of explanation, numerous specific details are set forth in order to provide a thorough understanding of the invention. It will be apparent, however, to one skilled in the art that the invention may be practiced without these specific details. In other instances, structures and devices are shown in block diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

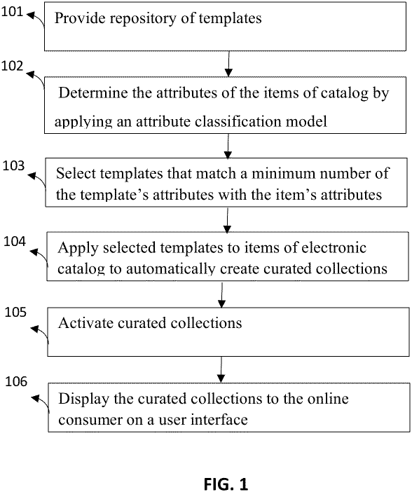

FIG. 1 illustrates the method of creating collections. A collection creation system creates a curated selection of items presented to an online consumer. The curated selection of items are derived from an electronic catalog of items in an online store. The collection creation system comprises a collection creation application module installed on the online store; and a database repository of templates 101, wherein each template is a blueprint for a set of collections that have the same attributes and similar themes. The templates are defined by one or more of: verticals, categories, attributes, metrics, and text filters. The method includes the following processes. Determine the attributes 102 of the items of catalog by an attribute classification model. Select templates 103 that match a minimum number of the template’s attributes with the item’s attributes. Apply the selected templates 104 to the items of electronic catalog to automatically create curated collections. Activate curated collections 105 and display the curated collections to the online consumer on a user interface 106.

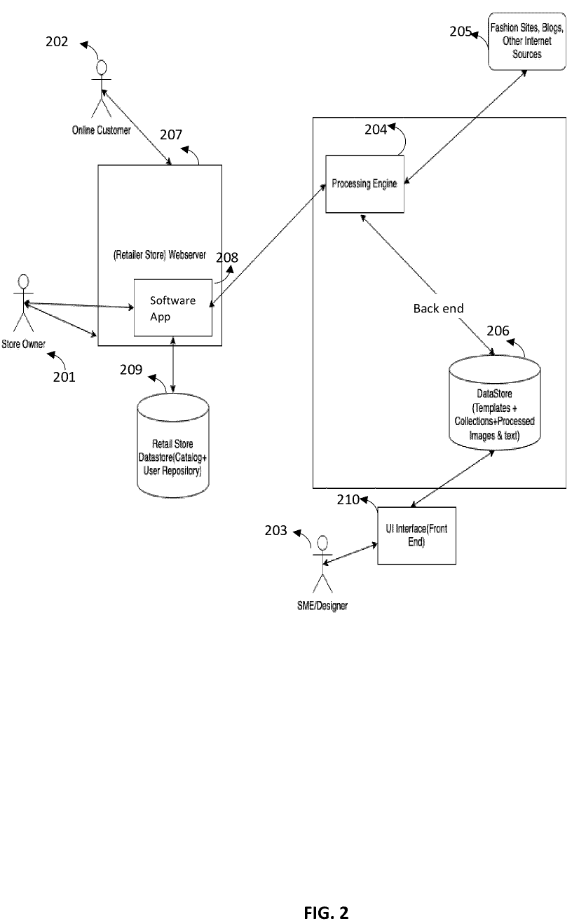

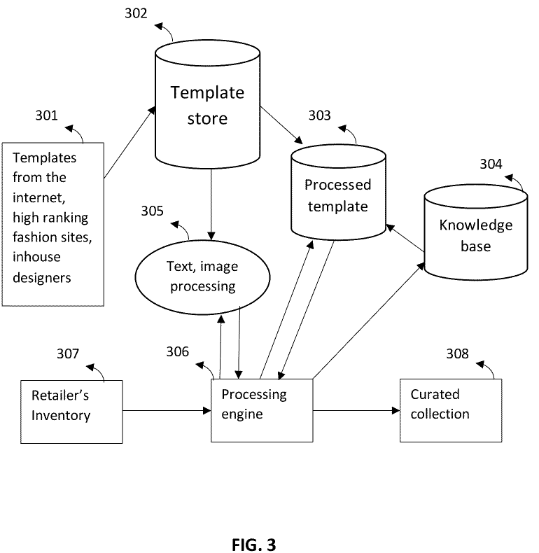

Templates are abstractions of collections. A template may be considered a blueprint for a set of collections that have the same attributes and similar themes. The same template can be used across several online stores. Templates are defined by verticals, categories, attributes, metrics and text filters. An extended range of templates is created automatically using the system and automated processes illustrated in FIG. 2 and FIG. 3. Unlike a collection, a template does not contain products and does not have states. There are two types of templates, Global and Local. Global templates can be used on any online store supported in the platform, for example it can be used on a Shopify™ store. Local templates may only be used within a store.

FIG. 2 illustrates an online ecommerce ecosystem comprising templates and collections.

Described herein is a computer implemented method of creating a template. The template is applied to an electronic/online catalogue of a retailer to create a curated collection of items for an online consumer 202. Identify themes via a computing device by textual and image processing, wherein each of the themes is a combination of entities such as occasions, events, festivals, and seasonal wear. Identify attributes via a computing device by automated textual search and image processing of the items. Map the theme(s) to attributes via a computing device to create a template(s). A map is a rule connecting themes to attributes. The template is not a product and does not have a state.

A software application 208 applies templates to create collections from the retail store catalogues 209 (of the storeowner 201) for the online consumer 202. A processing engine 204 processing information from information sources 205 and data stores 206, provides templates to the webserver 207. A subject matter expert 203, through a user interface 210, aids in the generation of an initial set of templates.

Below is an example of a simple template.
Name: Red Flowers
Category: Women
Attributes: Red, floral, vibrant
Description: “Stand out with our trendy red collection”

In one store, this template may be used to create a collection of red dresses with a floral pattern. The same template can be used in another store that specializes in sarees to create a collection of red sarees with floral patterns.

System templates are special templates that are created by developers based on store metrics. Examples of system templates are described below.

“Trending Template”: A template to create collections of products that are ‘trending’ i.e.: selling more since the last week or month.

“Brand Name Look Alike Template”: A template to create collections of products from a store that resemble “high end products”

“Celebrity Template”: A template to create collections of products from a store’s catalogue that resemble outfits worn by Celebrities at an event, etc.

The notation for a template is shown below:

Template : <template name><attribute 1..n><description><source>
Attribute : <category><brand><color><neckline><design><....><model face
image><model body type>
<vibrant>:<mapping regular English to catalogue attributes>

A subject matter expert (SME) 203 can use a template to create a collection for a store 207. The SME 203 can then ‘tweak’ the collection by adding or removing items from a collection.

A software application 208 is provided to automatically create templates, and to apply those templates to the store’s catalogue to create curated collections.

These collections can be immediately offered to a storeowner 201 to use on his or her website.

As an intermediate step, an SME 203 can choose to tweak the collection before presenting to a store owner 201.

FIG. 3 illustrates the method of creating a template. Templates 301 stored in a template store 302 are further processed 303 by applying a processing engine 206 to text and image processing 305 and a knowledge base 304, and further applying these templates to a retailer’s inventory 307 to create curated collections 308.

An initial set of templates can be created from existing collections created by SMEs 203 using a console, Machine Learning support with text and image analytics, using the attributes, filters, metrics and categories of the collection. In one embodiment, a console is provided to a subject matter expert (203) to create an initial set of templates that includes certain custom attributes (such as Comfortable, Vibrant, etc.). The SME 203 can define these custom attributes using other attributes such as color, style, design etc.

In another embodiment, system templates can be created by developers based on system metrics in combination with attributes, filters, metrics and categories.

SMEs 203 can create an initial set of templates with the aid of artificial intelligence (AI) tools from a selection of attributes, filters, metrics and categories.

One of the techniques used to create templates is from uploaded images from a console or App.

Console: In the collection creation page, an SME 203 or designer can create a template by uploading one or more images product(s). For example, this image may be one of a celebrity wearing a certain outfit at an award show. After uploading the images, the SME 103 can optionally further qualify it by choosing additional attributes for each image uploaded (Color, dress style, collar type, etc.)

A processing engine 306 uses the above information to create a template.

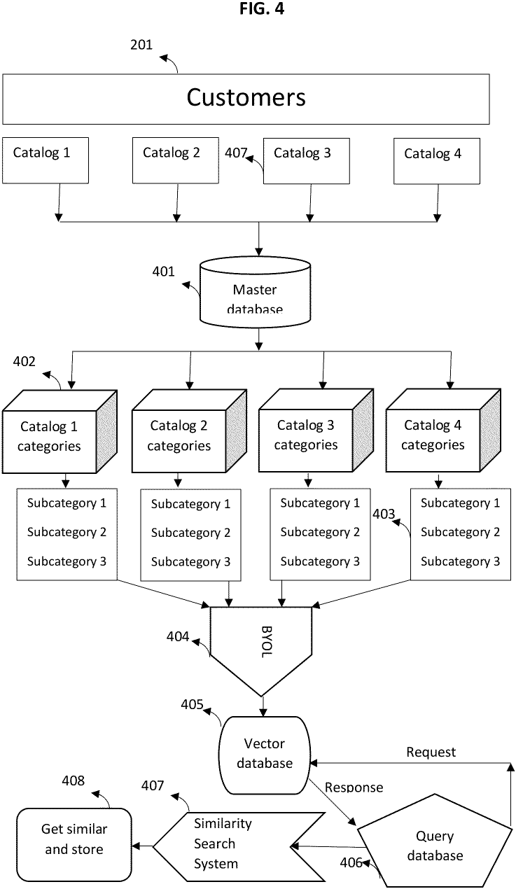

FIG. 4 illustrates the system for generating an extended range of templates.

Block 407 represents the retailer’s 201 electronic catalogue. The customer is the online retailer 201, and the consumer 202 is the end user. The master database 401 includes the template database, collection database and catalogue database. Merge the user events, i.e. the user clicks carts/events, and attribute data into the master database 401. Determine the similarity between categories and reduce complexity by classifying at the lowest level subcategory 403. The catalogue 402 is segmented into sub categories 403. For example, considering the men’s L0 L1 shirt size category. Exemplarily, in order to search for a Men’s polo shirt, select a subcategory 403 called Polo neck, and intelligently analyse the text and image, and determine that the product is classified under the Polo neck sub category 403, and thereafter get similar within the Polo neck subcategory 403. After a Bootstrap Your Own Latent (BYOL) 404, execute the “get similar” 408 step by applying vector similarity using a similarity search system 407. FAISS of Facebook is an example of such a similarity search system 407.The step of determining vector similarity is performed by querying through applying a request from query database 406 on a set of vectors stored in a vector database 405.

The following steps highlight the method of extending the range of template using similar.

Find the embedding vector for every image in the dataset by performing a forward pass on a trained BYOL encoder using all images from the dataset.

Use FAISS, a library for efficient similarity search and clustering of dense vectors. Create a FAISS index from the embedding. This index is a sorted version of the embedding according to some metric (such as Euclidean distance).

Given a test image, find the embedding and quickly locate the similar images from the created FAISS index. If required, add the new image to the dataset and the embedding to the Faiss index.

For a given a set of vectors xi in dimension ‘d’, FAISS builds a data structure in RAM from it. After constructing the data structure, given a new vector x in size ‘d’, FAISS performs the following operation efficiently:

argmini | | xi -x | |

where ||.|| is the Euclidean distance (). FAISS essentially finds the index ‘i’, which contains an embedding vector closest (similar) to the test image’s embedding vector. The FAISS index can then be stored and used for finding similar images.

Template Mapping is based on concepts/themes, attributes and personalized data. A concept/theme is a combination of entities such as occasions, events, festivals, seasonal wear, etc.; along with a description of those entities. Each of these maps to attributes that are entered by a subject matter expert or automatically inferred by a machine learning (ML) algorithm. For e.g., if we define a concept as Vibrant summer collection - map vibrant to colors red green blue and summer to light colors, relaxed fit clothes, etc. This mapping of a theme to a set of attributes is a template. Templates are reusable across multiple stores. Templates can be created through text and image processing. In one embodiment, an extended range of templates by text and image processing, and the processes illustrated in FIG. 3. In an embodiment an extended range of templates are created from an initial set of templates. When image processing is applied to create templates, sample images are used that visually depict a theme/concept, and that have the right set of attributes. Use vector similarity to find similar images and store these as templates. From these templates create collections by grouping products that have similar attributes and user metrics.

Template definition <Entity Name, Description, attributes like category, style, pattern, image urls, user metrics like click/cart ratio, click/order ratio>

The master database contains all the template definitions, splits it into multiple flows each per sub category of a customer, and uses a vector database to store the representations.

Described herein is the process of template sorting using a console. A sorting order can be set for a template while it is being created or updated. The sort order may be alpha-numeric and in ascending or descending order, based on price, available inventory, bestsellers or a custom sort based on clicks, carts and orders on products. Other advanced sorting orders like clicks to order ratio, random order may also be used. Collections created with such a template will use the sort order configured with the respective template.

Described herein is the process of template sorting using a software application. A store owner creating a template through the software application will also be able to set the sort order for the template based on criteria described above. Collections created with such a template will use the same sort order as that specified for the template.

Described herein is a method and system for collection creation. The collection is a curated selection of product and/services presented to an online consumer. The products or services are derived from an electronic catalogue of an online store. The creation system comprises a processor, a collection creation application module installed on the online store, a database repository of global templates, and a memory containing instructions, when executed by the processor, configure the system to apply the global templates to the electronic catalog to automatically create curated collections of product items; and to activate said create collections and presenting the collections to the online consumer.

The computer implemented method of creating a collection is described herein. Provide a collection creation application module, installed on the online store. Provide a repository of global templates. Apply global templates to the electronic catalog to automatically create curated collections of said product items. Activate the created collections and present the collections on a website to the online consumer.

The attributes, metrics, filters and categories of said global templates are applied to the electronic catalog to automatically create curated collections.

As a prerequisite to belong to a collection, a product must match a minimum subset of attributes, metrics, filters and categories of said global template.

Described below are the process steps for collection creation:
Store owner opens URL for Custom app.
Store owner installs app
Collection creation module receives notification that a new store has been added
Collection creation module processes product catalog and user data.
Collection creation module fetches attributes and their corresponding value(s) for each product in Product catalog and saves it in platform
Collection creation module fetches list of system templates in system
For each template:
   Create empty collection
   For each attribute in template:
      For each saved product in Collection creation module
         Set attribute _count to 0;
         Check if the template attribute exists for saved product
Check if the attribute value for template attribute matches the value of the same attribute in the product
If there is a match,
   increment attribute_count
If attribute_count >= minimum _attribute_threshold
Add product to collection
If number of products in collection < min_products_in_collection
Delete collection
If there is no exact match of a color attribute, identify and include product items whose color is in close proximity to the color(s) specified in the template.

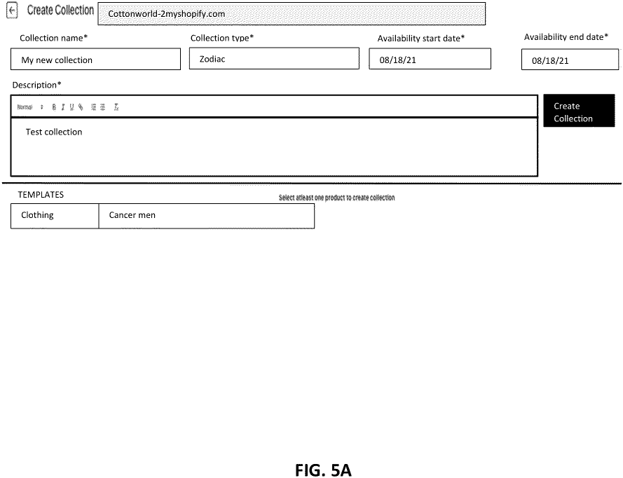

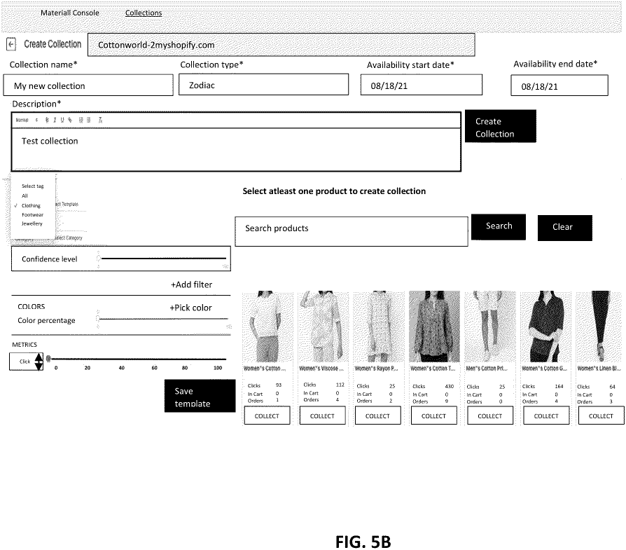

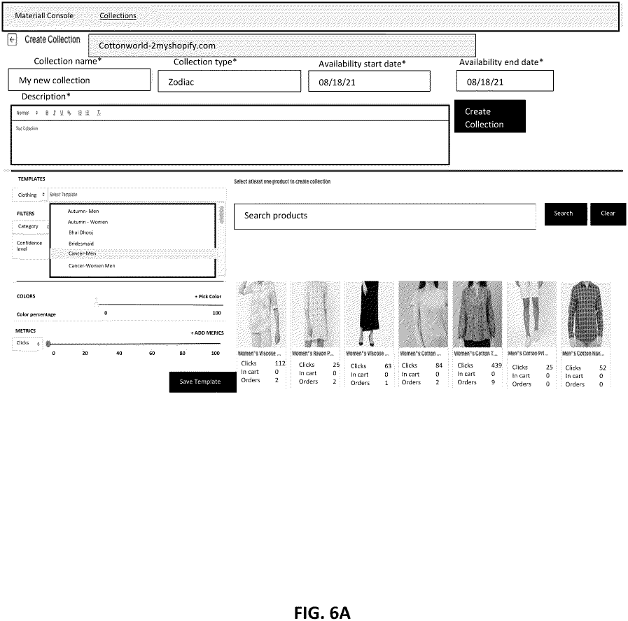

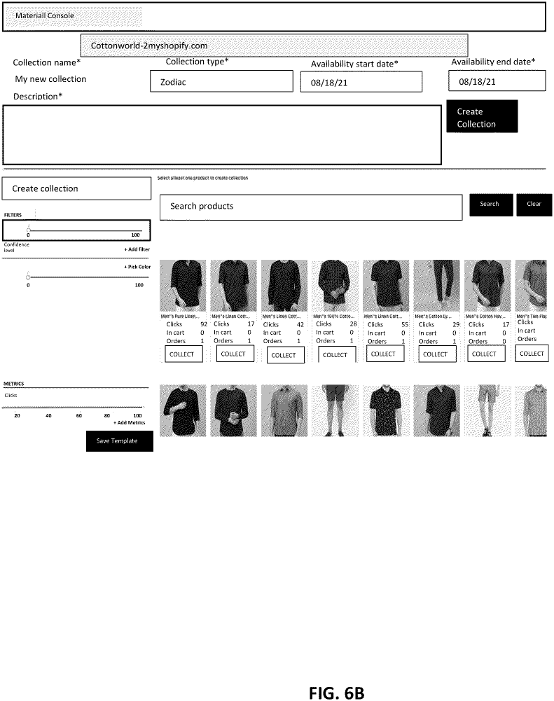

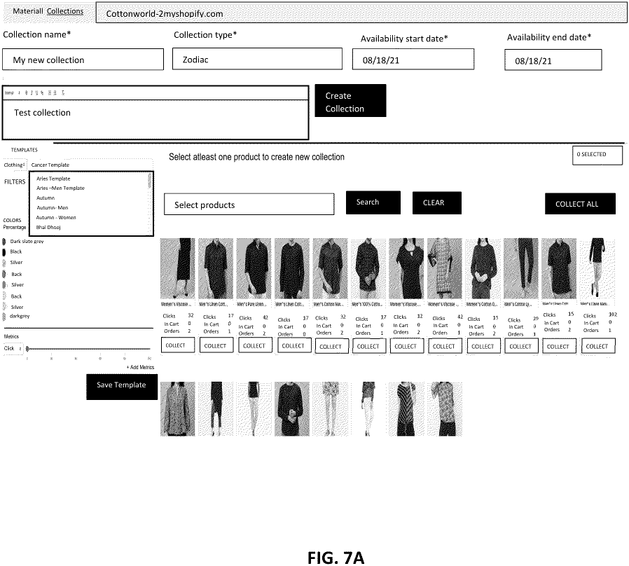

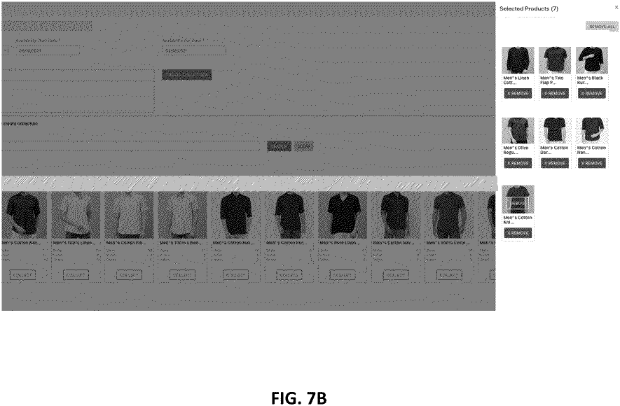

In another embodiment, the automatically curated collection is presented on a website to a subject matter expert for inputs of addition or removal of product items, and thereafter providing a refined set of curated collections. FIG. 5A exemplarily illustrates a user interface for the provision of a name and description of a collection. FIG. 5B exemplarily illustrates a user interface for selecting a tag to select a vertical, e.g., clothing. FIG. 6A exemplarily illustrates the step of clicking and selecting products for a collection. FIG. 6B exemplarily illustrates the step of selecting a template, example “cancer men”. FIG. 7A exemplarily illustrates the addition of add new filters, metrics and colors as necessary. FIG. 7B exemplarily illustrates the view of the collection.

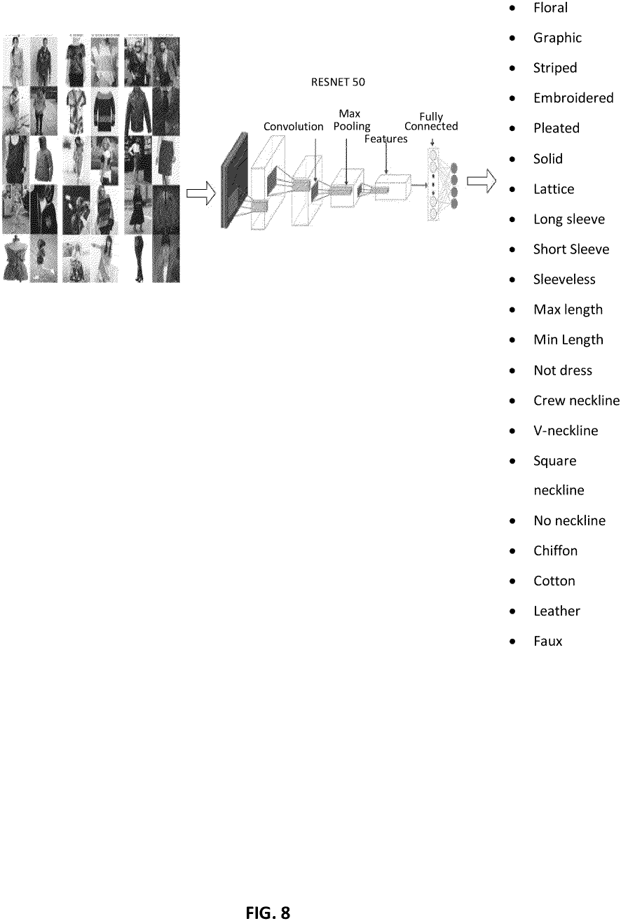

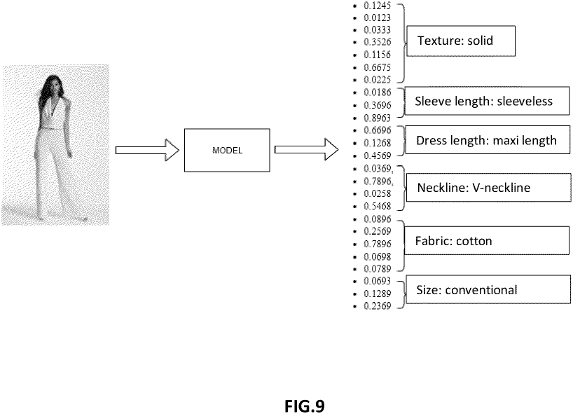

A collection is marked activated either automatically by the platform or by an administrator. When a store owner adds a collection after a notification, the collection is in usable state and the store owner can now place the collection in the pages the online store. The collection can be updated with new products added to it or with some products removed from it, and wherein after the updation, an electronic notification is sent either by the admin or by the online platform to the store owner. A collection is marked updated and activated when a store owner approves the update. A collection may be marked deactivated by a subject matter expert. The process of attribute classification is described herein. Attribute classification is considered as a multi-label classification problem. Exemplarily, there are 26 classes in total. Each data in the dataset consists of an image with the corresponding attribute label. FIG. 8 illustrates the training for attributes. Perform supervised learning using the Resnet 50 architecture, and save the trained model. Given a new image (image shown in FIG. 9), the model outputs the probability of each class.

FIG. 9 illustrates the probabilities based on the attributes. There are 26 classes, and only six attributes are required. Therefore, first group these probabilities based on the attribute they belong to, and then choose the maximum value in each group.

The processing steps described above may be implemented as modules. As used herein, the term “module” might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skills in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

In general, the modules/routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution.

Modules might be implemented using a general-purpose or special-purpose processing engine such as, for example, a microprocessor, controller, or other control logic. In the illustrated example, the modules could be connected to a bus, although any communication medium can be used to facilitate interaction with other components of computing modules or to communicate externally.

The computing server might also include one or more memory modules, simply referred to herein as main memory. For example, preferably random access memory (RAM) or other dynamic memory, might be used for storing information and instructions to be executed by processor. Main memory might also be used for storing temporary variables or other intermediate information during execution of instructions to be executed by a processor. Computing module might likewise include a read only memory (“ROM”) or other static storage device coupled to bus for storing static information and instructions for processor.

The database module might include, for example, a media drive and a storage unit interface. The media drive might include a drive or other mechanism to support fixed or removable storage media.

In alternative embodiments, the database modules might include other similar instrumentalities for allowing computer programs or other instructions or data to be loaded into the computing module. Such instrumentalities might include, for example, a fixed or removable storage unit and an interface. Examples of such storage units and interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A collection creation system to create a curated selection of items presented to an online consumer, wherein said curated selection of items are derived from an electronic catalog of items in an online store, said collection creation system comprising:
a collection creation application module installed on said online store;
a repository of templates, wherein each template is a blueprint for a set of collections that have the same attributes and similar themes, and wherein said templates are defined by one or more of: verticals, categories, attributes, metrics, and text filters;
a processor; and
a memory containing instructions, when executed by the processor, configure the system to:
determine the attributes of the items of catalog by an attribute classification model;
select templates that match a minimum number of the template’s attributes with the item’s attributes;
apply said selected templates to said items of electronic catalog to automatically create curated collections;
activate said curated collections; and
display said curated collections to the online consumer on a user interface.

2. A computer implemented method of creating a collection, wherein said collection is a curated selection of product items presented to an online consumer, and wherein said product items are derived from an electronic catalog in an online store, said method comprising:
providing a collection creation application module installed on said online store;
providing a repository of global templates;
determining attributes of items included in the electronic catalog by an attribute classification model;
selecting templates that match a minimum number of the template’s attributes with the item’s attributes;
applying said selected templates to said items included in the electronic catalog to automatically create curated collections;
activating said curated collections; and
displaying said curated collections to the online consumer on a user interface.

3. The method of claim 2, wherein attributes, metrics, filters, and categories of said global templates are applied to the electronic catalog to automatically create curated collections.

4. The method of claim 2, wherein as a prerequisite to belong to a collection, a product must match a minimum subset of attributes, metrics, filters, and categories of said global template.

5. The method of claim 2, wherein if there is no exact match of a color attribute, identify and include product items whose color is in close proximity to the color(s) specified in the template.

6. The method of claim 2, further comprising presenting said automatically curated collection on a website to a subject matter expert for inputs of addition or removal of product items within said automatically curated collections, and thereafter providing a refined set of curated collections.

7. The method of claim 2, wherein said template is a blueprint for a set of collections that have the same attributes and similar themes.

8. The method of claim 2, further comprising defining said template by verticals, categories, attributes, metrics, and text filters.

9. The method of claim 2, wherein said template is a system template that is created by developers based on store metrics.

10. The method of claim 2, wherein said template is a trending template that creates collections of products that are top sellers.

11. The method of claim 2, wherein said template is a “Brand Name Look Alike Template” that is applied to said electronic catalog to create collections of products from a store that resemble high end branded products.

12. The method of claim 2, wherein said template is a celebrity template that is applied to said electronic catalog to create collections of products from a store’s catalogue that resemble outfits worn by celebrities.

13. The method of claim 2, wherein said templates are created by developers based on system metrics in combination with attributes, filters, metrics, and categories.

14. The method of claim 2, wherein a collection is marked activated either automatically by a platform or by an administrator.

15. The method of claim 2, wherein when a store owner adds a collection after a notification, the collection is in usable state and the store owner can now place the collection on pages of his or her store.

16. The method of claim 2, wherein the collection can be updated with new products added to it or with some products removed from it, and wherein after said updation, an electronic notification is transmitted either by an administrator or by a platform to a device associated with a store owner.

17. The method of claim 2, wherein a collection is marked updated and activated when a store owner approves the update.

18. The method of claim 2, wherein a collection may be marked deactivated by a subject matter expert.
